(19) United States
(12) Patent Application Publication
(10) Pub. No.: US 2015/0166317 A1
(43) Pub. Date: Jun. 18, 2015

(54) HYBRID CAPPER

(71) Applicant: Eli Uriel, Bronx, NY (US)

(72) Inventor: Eli Uriel, Bronx, NY (US)

(21) Appl. No.: 14/570,877

(22) Filed: Dec. 15, 2014

Related U.S. Application Data
(60) Provisional application No. 61/916,349, filed on Dec. 16, 2013.

(51) Int. Cl. B67B 3/20; B67B 3/26

(52) U.S. Cl. CPC B67B 3/2053; B67B 3/265; B67B 3/261

(57) ABSTRACT

Disclosed herein is an automated bottle capping system comprising a bottle handling assembly and a capping head assembly. The bottle handling assembly comprises a conveyor belt having a spacing mechanism to time and deliver spaced bottles to the bottle conveyor section. The conveyor belt further comprises parallel gripping belts in the bottle conveyor section. The capping head assembly comprises a cap sorter/feeder having a gravity or linear track, thirteen chuck spindle assemblies to pick up and grip the caps, and a combined pickup/conveyor/torqueing means, for picking up the caps, spinning the caps at a pre-selected amount of torque, tightening them to a closed configuration, and moving the capped bottles away from the linear capping section to a subsequent handling station. The capping head assembly also comprises a timing means for pairing bottles and caps. The capping head assemblies are mounted around a racetrack, having two linear tracks. The chuck spindle assemblies only move around the racetrack. A method of bottle capping using an automated system is also described.

### CROSS REFERENCE TO RELATED APPLICATION

This application claims priority from Provisional Application Ser. No. 61/916,349, filed Dec. 16, 2013.

### FIELD OF THE INVENTION

The present invention relates to improvements in bottle capping machinery and systems and methods of operating the same.

### BACKGROUND OF THE INVENTION

Automated bottle capping machines in the prior art vary in complexity and are designed with regard to bottle and cap requirements, throughput rate requirements, ease of set-up, subsequent alteration and repair.

The prior art includes spindle capper machines. Spindle capper machines are relatively inexpensive, have a high rate throughput (e.g. up to 180 pieces per minute) and are easy to changeover as required. However, such spindle capper machines exhibit several disadvantages such as, providing inconsistent torque, frequent miss-feeding of caps (particularly large caps) and are limited in the range of caps and bottles they can handle.

Another type of machine included in the prior art is a chuck capper machine. The chuck capper machine provides gentle handling of bottles and caps, precise torque control, optional torque feedback with servo motor controls, and is able to work with a wide range of bottles and caps. However, the chuck capper machine exhibits its own set of disadvantages such as expensive to buy and install, not readily expandable, has complicated changeovers and requires expensive change parts (e.g., timing screws, star wheels, guideplates, chucks, and the like).

The automated hybrid capper of the present invention eliminates all of the foregoing drawbacks. The hybrid capper will generally have a price range between that of the chuck capper and spindle capper, it has fewer, if any, changeover parts and would be easy to make the changeover in any event. The hybrid capper provides for gentle handling of bottles and caps, which is particularly important for relatively delicate assemblies. The hybrid capper described herein provides precise torque control for exact closed conformations, and torque feedback (e.g. with servo motor control) when made available. The hybrid capper can be adapted to handle high speeds as well as a wide range of bottles and caps.

The present invention minimizes each of the aforementioned problems, providing for a unique bottling system. Furthermore, use of the instant system design can enhance the efficiency of bottling systems in a wide variety of commercial operations and environments. In addition to the capping operation, the system can be adapted for assembling various other parts in a similar manner.

### SUMMARY OF THE INVENTION

The present invention is directed to an improved apparatus, system and method for automatic bottle capping operations.

The present invention discloses an automated bottle capping system which comprises a bottle handling assembly and a capping head assembly, wherein the bottle handling assembly and capping head assembly are substantially integrated in one system.

The bottle handling assembly comprises a conveyor belt having a spacing mechanism, to time and deliver spaced bottles to a bottle conveyor section. The conveyor belt further comprises parallel gripping belts in the bottle conveyor section to prevent the bottles from spinning The capping head assembly comprises a cap sorter/feeder having a gravity track, up to thirteen chuck spindle assemblies (more are possible with a larger size frame machine) to pick up and grip the caps, and a combined pickup/conveyor/torqueing means, for picking up caps, placing the caps on the bottles, tightening to a closed configuration at a pre-selected amount of torque, and removing the capped bottles from the linear capping section to a subsequent handling station. The capping head assembly also comprises a timing means for pairing bottles and caps. The capping head assemblies are mounted around a racetrack, having two linear tracks. The chuck spindles only move around the racetrack. The bottles are not diverted from the conveyor.

The present invention also provides a method of bottle capping using an automated system. The bottle handling assembly has one operation mode whereas the capping head assembly has four operation modes, including pre-capping stage, capping stage, post-capping mode and staging mode. The capping head assembly operates according to different protocols depending on their respective operation modes.

### BRIEF DESCRIPTION OF THE DRAWINGS

FIG. 1 is a front perspective view of an exemplary hybrid bottle capping apparatus;

FIG. 2 is a back perspective view of an exemplary hybrid bottle capping apparatus;

FIG. 3 is a zoomed perspective view of the cap heading assembly of the bottle capping apparatus of FIG. 1;

FIG. 4 is a zoomed perspective view of the cap heading assembly of the bottle capping apparatus of FIG. 2;

FIGS. 5 and 6 are further detailed views of the cap heading assembly of the bottle capping apparatus of FIGS. 3 and 4, respectively;

FIG. 7 is a top view of the bottle capping apparatus of FIG. 1;

FIG. 8 is a process diagram of one embodiment of the bottle handling assembly in accordance with the present method;

FIG. 9 is a process diagram of one embodiment of the capping head assembly in accordance with the present method, wherein the capping head assembly is in its pre-capping mode;

FIG. 10 is a process diagram of one embodiment of the capping head assembly in accordance with the present method, wherein the capping head assembly is in its capping mode;

FIG. 11 is a process diagram of one embodiment of the capping head assembly in accordance with the present method, wherein the capping head assembly is in its post-capping mode; and

FIG. 12 is a process diagram of one embodiment of the capping head assembly in accordance with the present method, wherein the capping head assembly is in its staging mode.

### DETAILED DESCRIPTION OF THE PREFERRED EMBODIMENTS

The present invention discloses apparatus, systems and methods for automated bottle capping.

Capping is often a challenging aspect of a packaging line for several reasons. The issues that arise may center on the wide range of geometries and sizes of caps and bottles. The difficulties may arise from the necessity of matching of the bottle and cap threads. The present invention addresses such challenges and others.

### Variety of Caps

The systems and methods described herein are directed to screw caps, but are readily adapted to a wide variety of caps, such as crimp caps and tamp on caps, having different sizes, geometries and tightness. The present systems can accommodate caps having diameters of 5 mm or more.

### Containers

The term “bottle” as used in describing the present invention is intended to mean all of the different kinds of containers, which can stand on one surface without support. The term “bottle” also is intended to mean any kind of containers that can ride on a conveyor belt as shown in the drawings of the present invention. The bottle can be of any size or geometry, and can be filled with pharmaceuticals, cosmetics, chemicals and food. Further, the containers can be made of plastic, glass, tin or aluminum.

The hybrid capping machine described in the present invention is a stand-alone system. The machine can quickly and precisely marry desired caps or lids to filled containers as delivered from the filling station and return them to the packaging station or packaging line for downstream operations.

The hybrid capping system of the present invention features flexibility coupled with cost effective operation and easy changeover. Advantages of the system of the present invention include:

The system of the present invention can be used with almost any bottle, no change of parts is needed, only adjustment is required;

All of the caps are torqued with servomotors for highly reliable and precise torque application, or the system can be equipped with individual mechanical or magnetic clutches;

The present invention offers a flexible cap selecting system, which accommodates many different types of caps with easy and simple change over tooling. The cap is completely exposed at the time of pickup;

The present invention further offers an easy on screen torque adjustment with untorqued cap feedback through a friendly user interface.

In the figures, the following reference numerals are utilized for the respective elements:

The numbers are position points on the track, whereas the letters represent parts of the system.

Position (1) is a staging point where spindles are moving on the carousel/racetrack at an adjustable speed based on line speed and spaced six inches apart center to center;

Position (2) represents the point at which the spindle is above the bottle and is moving at the same speed and aligned with the bottle;

At position (5), a spacing wheel creates a six-inch gap between the bottles and do the initial registration of the bottle with spindles;

At position (6), the accelerator belts do the final registration of the bottle with the spindles;

Between positions (3) and (4), the spindle is transferred to the rear linear track;

Between positions (2) and (3), the capping occurs; and

Between position (4) and (1), a new cap is picked up by the spindle chuck.

### Parts of the System

A—Cap pick-up pegs

B—Carousel drive motor

C—Bottle presence sensor 1 and 2

D—Torque servo motors

F—Conveyor (cap delivery)

G—Conveyor (bottle handling)

H—Spacing wheel

I—Gripper belt×2

J—Chuck spindle assembly

K—Sorter track

L—Untorque belt

M—Torque belts

N—Chuck

The present invention as disclosed herein is directed to an automated bottle capping system that comprises a bottle handling assembly and a capping head assembly.

The bottle handling assembly comprises a conveyor belt for transporting filled bottles from a prior filling operation, through a spacing mechanism, to time and deliver spaced bottles to a bottle conveyor section of the system. The conveyor belt has a linear section, having a spacing mechanism. In one example, the spacing mechanism is a spacing wheel (H), which will create the six-inch spacing between the bottles and register the bottle with the spindle. In the linear section, the conveyor belt further comprises a pair of parallel accelerator belts in the bottle conveyor section to correct the registration with the spindles.

The capping head assembly comprises a cap sorter/feeder adapted to provide caps to a cap pickup section where they are individually fitted to one or more torqueing chucks, wherein the cap sorter/feeder allows the cap to be completely exposed for pick up. The cap sorter/feeder further comprises a gravity track for arranging the caps in a linear fashion so that they are ready for pick up one at a time.

The capping head assembly comprises thirteen chuck spindle assemblies to pick up and grip the caps.

The capping head assembly further comprises a combined pickup/conveyor/torqueing means, for picking up caps, placing the caps at a pre-selected amount of torque and tightening the cap on the bottle to a closed configuration, and removing the capped bottles from the linear capping section to a subsequent handling station.

The capping head assembly also comprises a timing means for pairing bottles and caps. The timing means allows the bottles to arrive at the capping point at the same time as the caps.

The capping head assemblies are mounted around a closed loop. The chuck spindles only move around the closed loop in a circular motion rather than in a back and forth linear motion.

The closed loop substantially resembles a race track configuration, which race track comprises two linear tracks. The race track has opposing curved sections and opposed linear sections. The racetrack comprises a chain carrying the capping head assemblies and is driven by an AC motor.

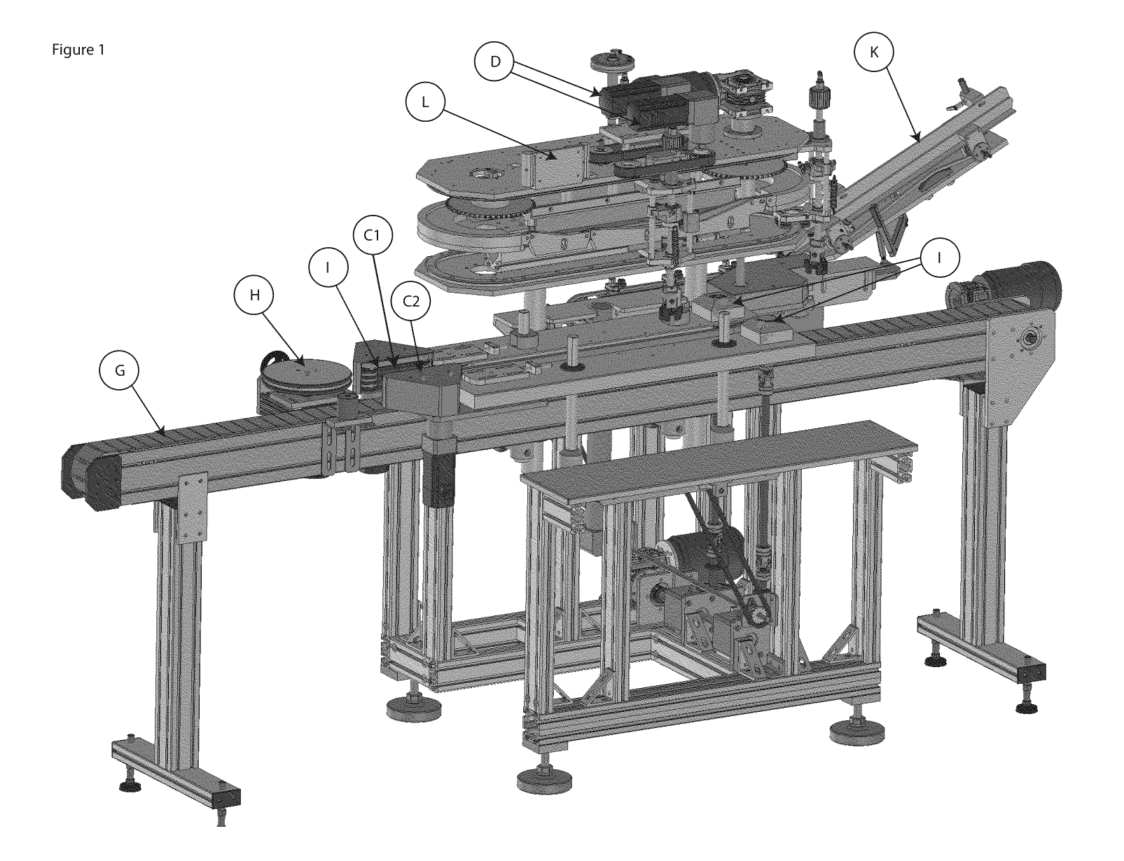

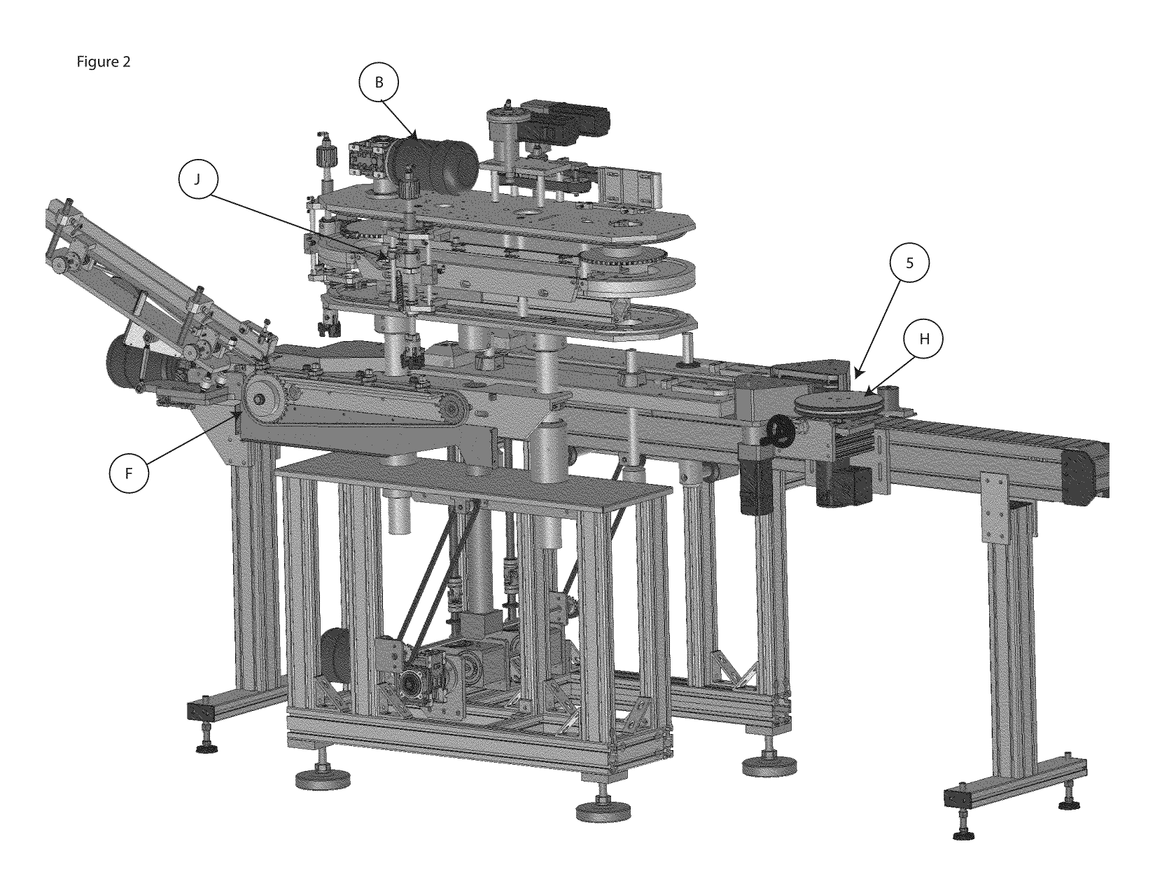

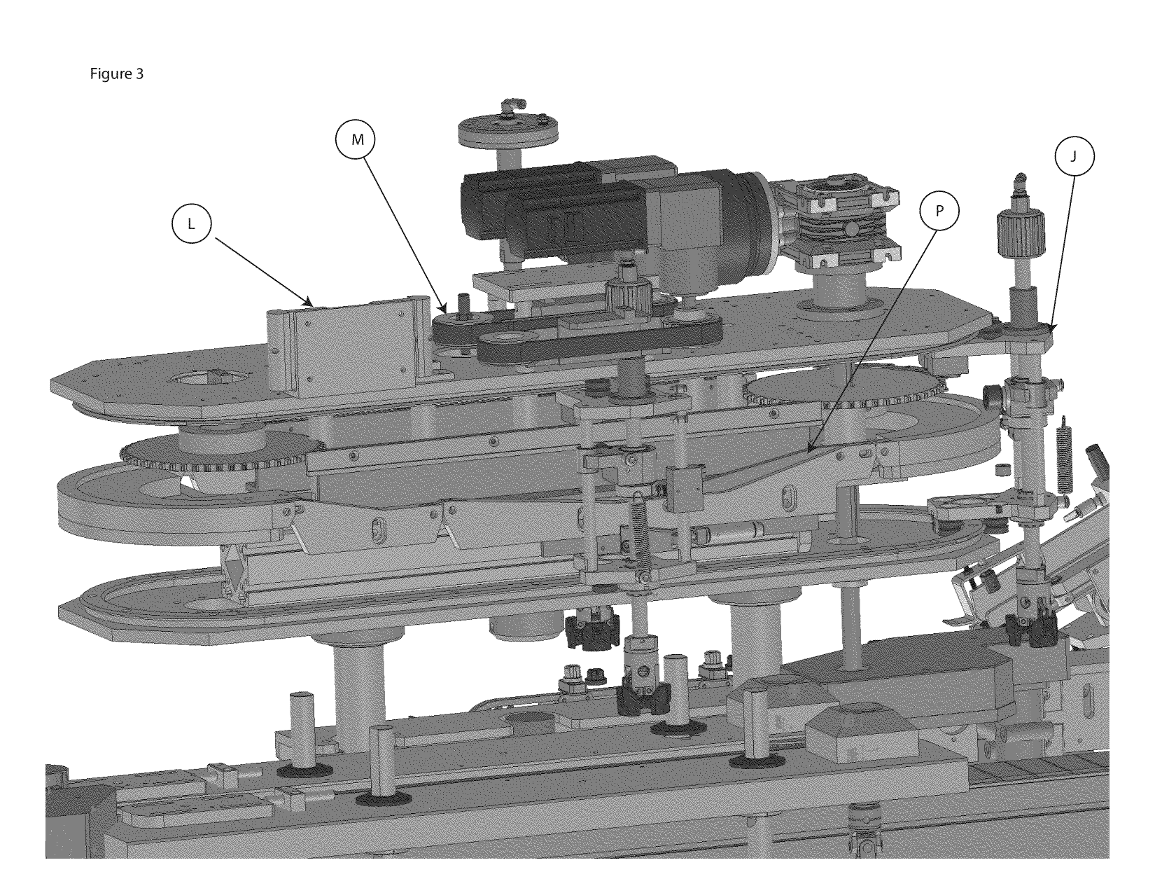

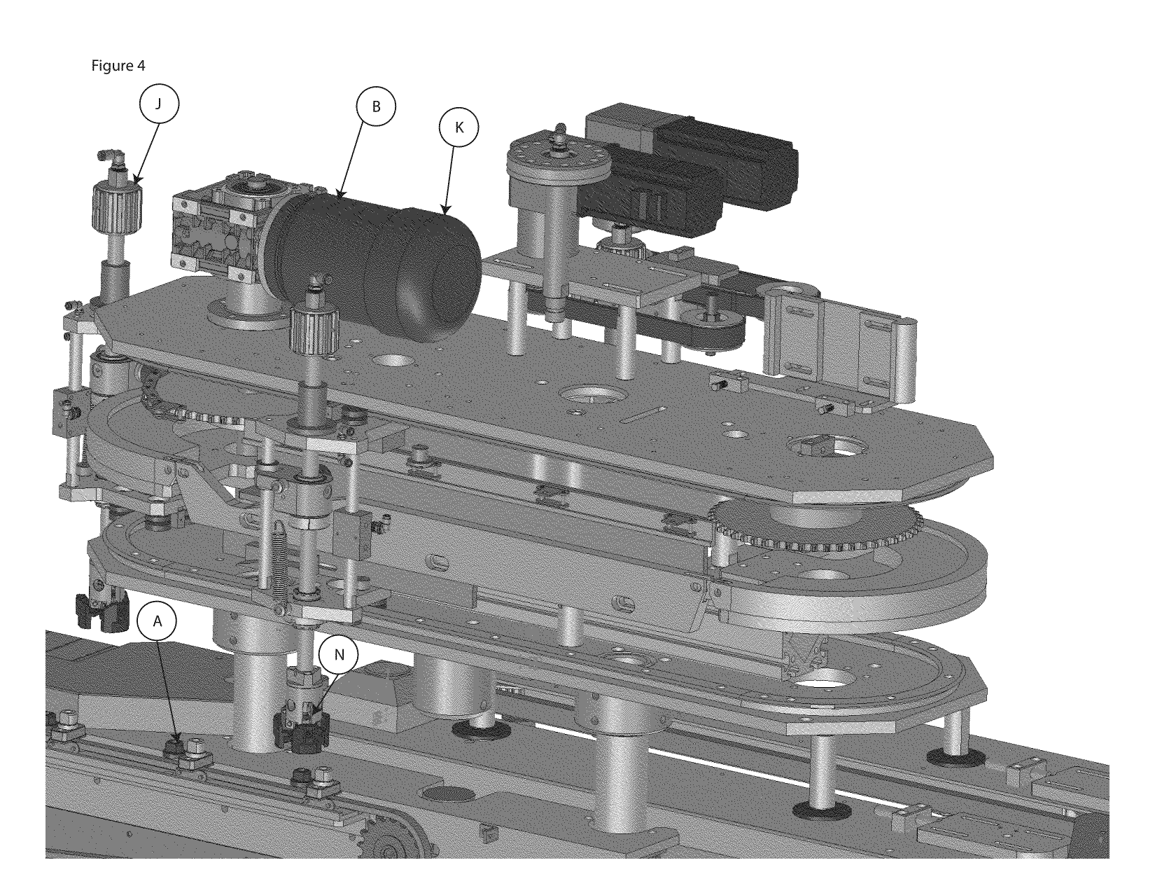

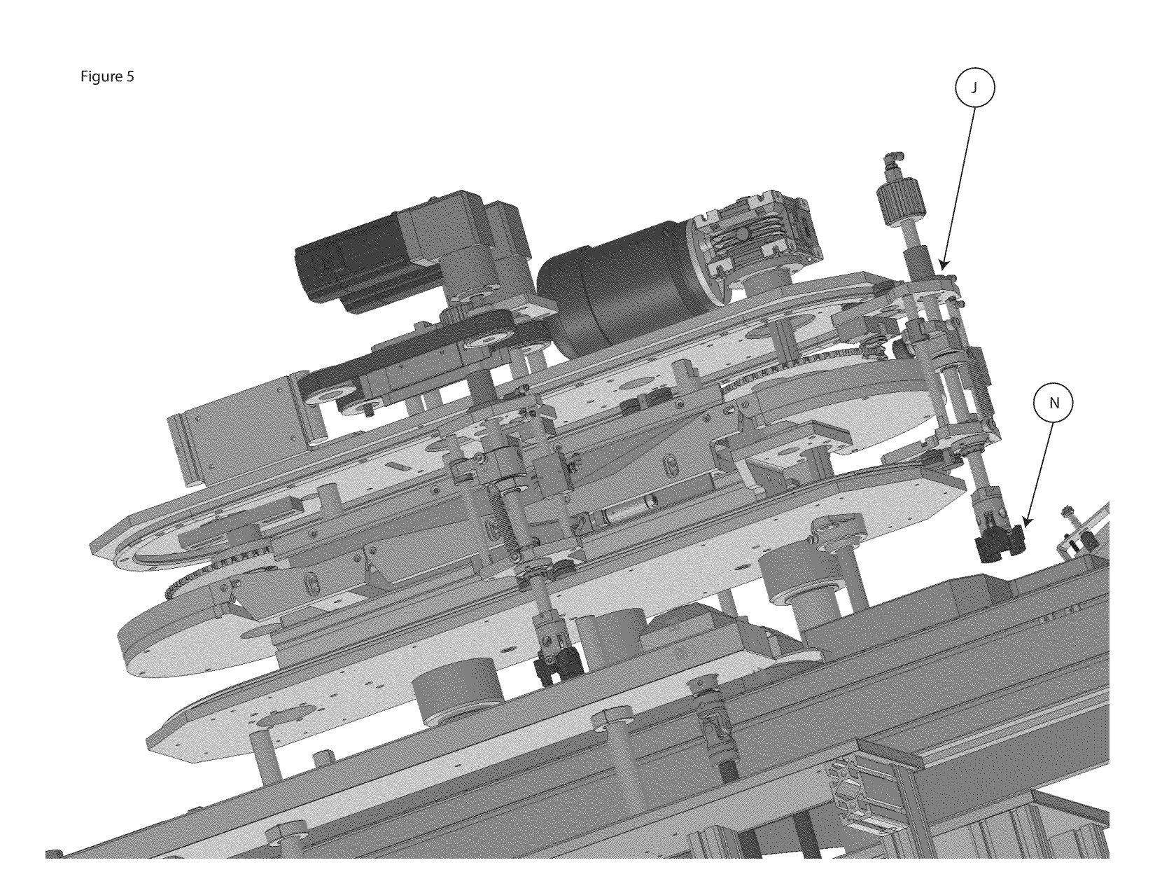

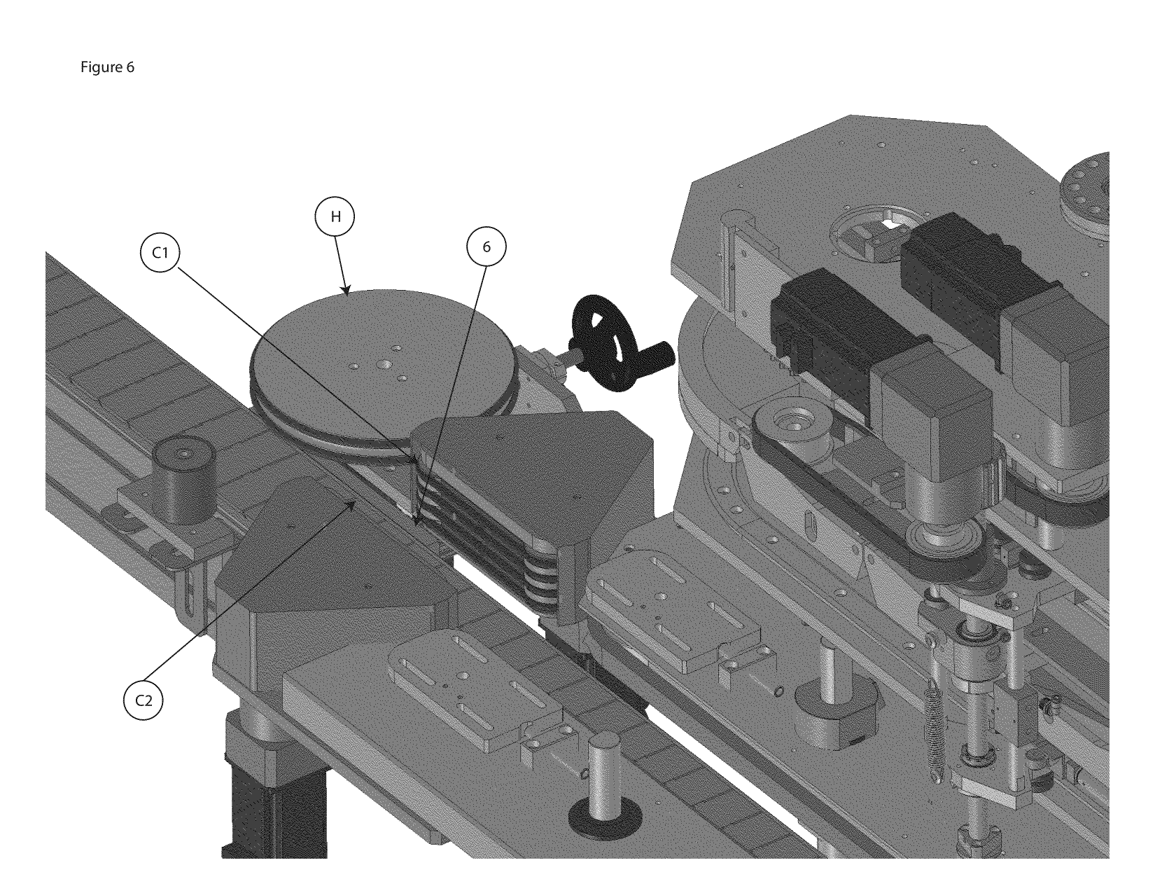

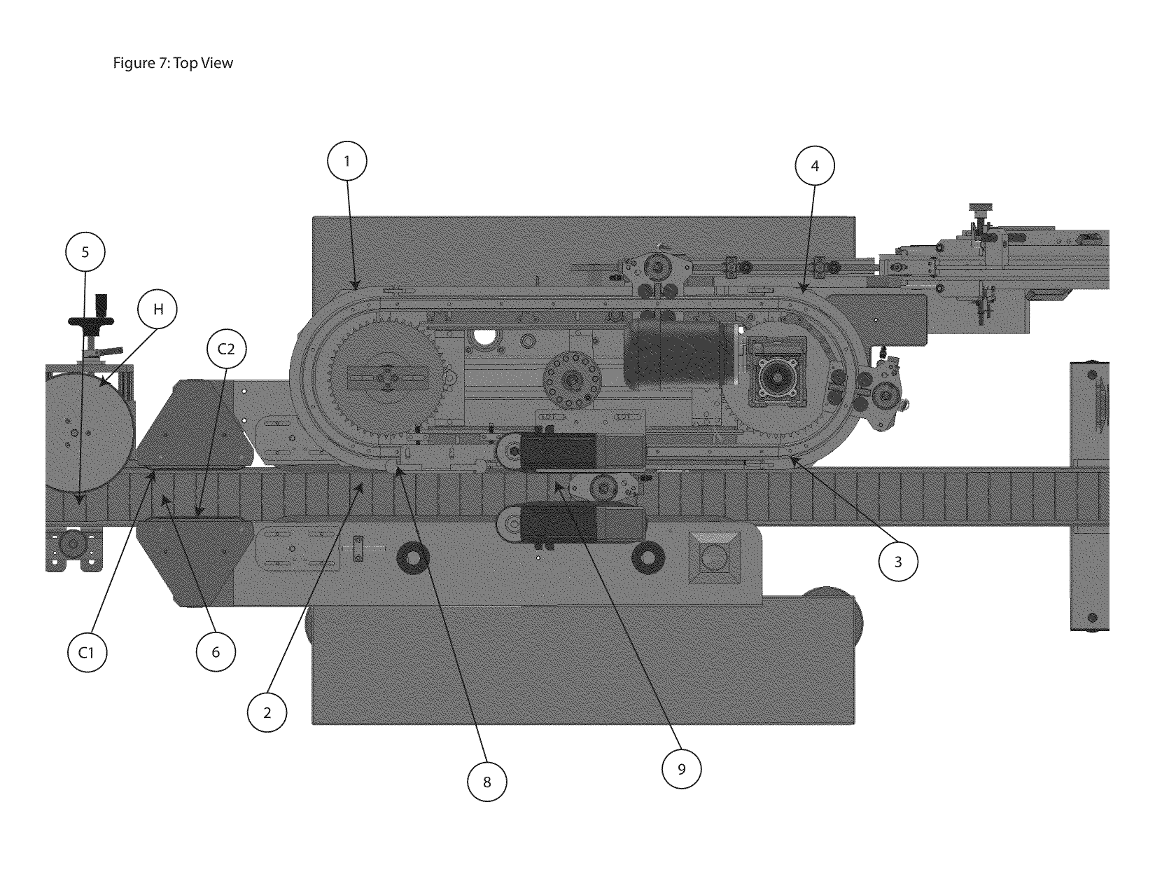

Up to thirteen spindles for this size machine can be mounted separately around the race track (Increasing the number of spindles will result in higher speed of capping and a larger machine). Only two are shown in FIGS. 1-7. The chuck spindles only move around the racetrack in a circular motion.

The chuck spindle assembly further comprises a chuck spindle gripper belt.

The capping head assembly further comprises a cam at positions 2 and 4 for moving the chuck spindle assembly up or down.

The capping head assembly further comprises a user or operator interface, providing on screen torque adjustment with untorqued cap feedback. Optionally, the user/operator interface can also provide for on screen conveyor speed adjustment. The user/operator interface is a touch screen device.

In the present invention, an electrically driven cap torque having an adjustable tightening mechanism tightens the caps to the required torque. In one example, the torque is controlled by servo-driven parallel belts having a completely electronic adjustment of the torque of the servo motors. With the system disclosed herein, changing over in order to adapt to different caps is easy. Only replacement of the cap pick-up pegs (A) and the chucks (N) is needed. The system is designed to handle caps and products delicately and gently, regardless of the torque setting chosen. In order to adapt to different bottles, the chuck height adjustment is required as well as the gap between the belts and the height of the parallel belts.

The present invention also provides a method of bottle capping using an automated system.

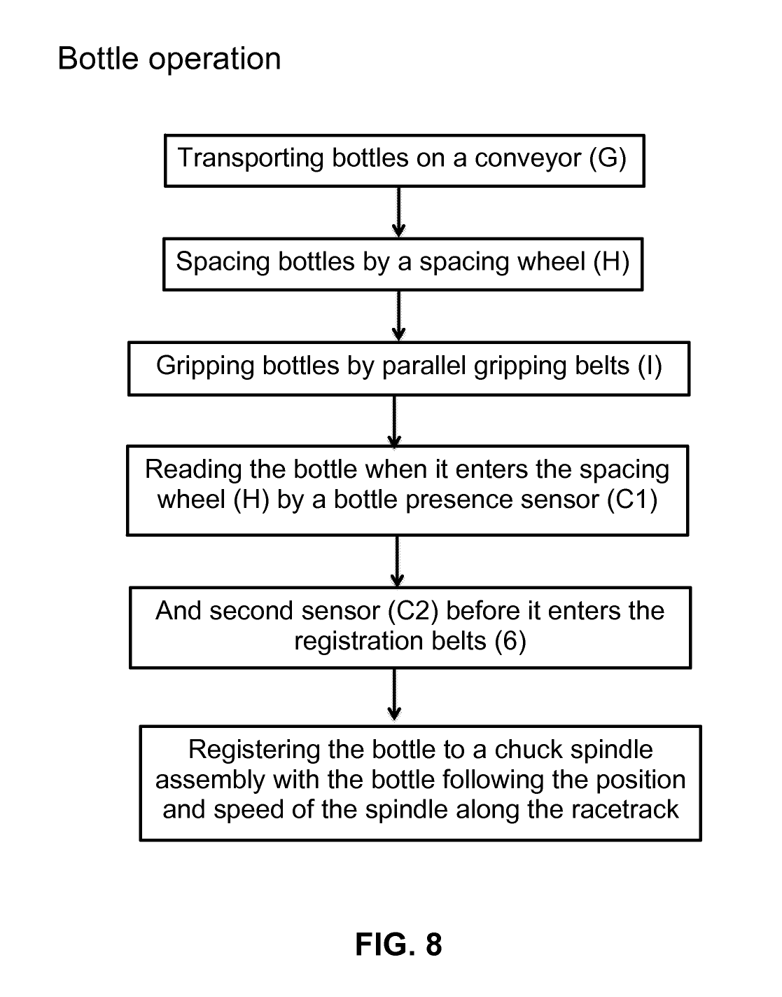

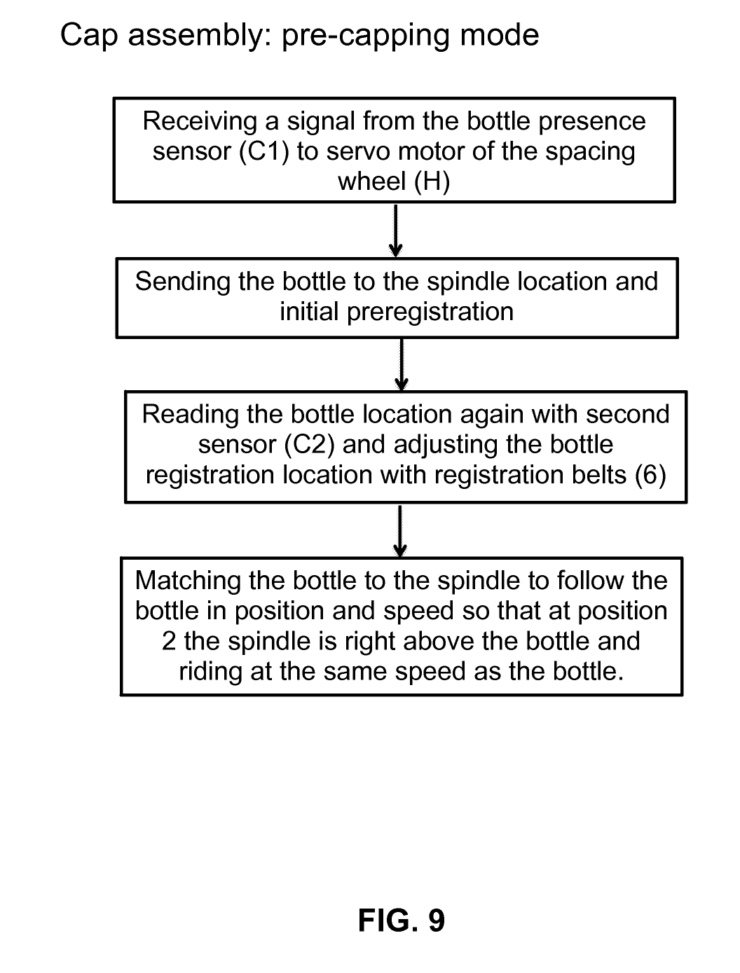

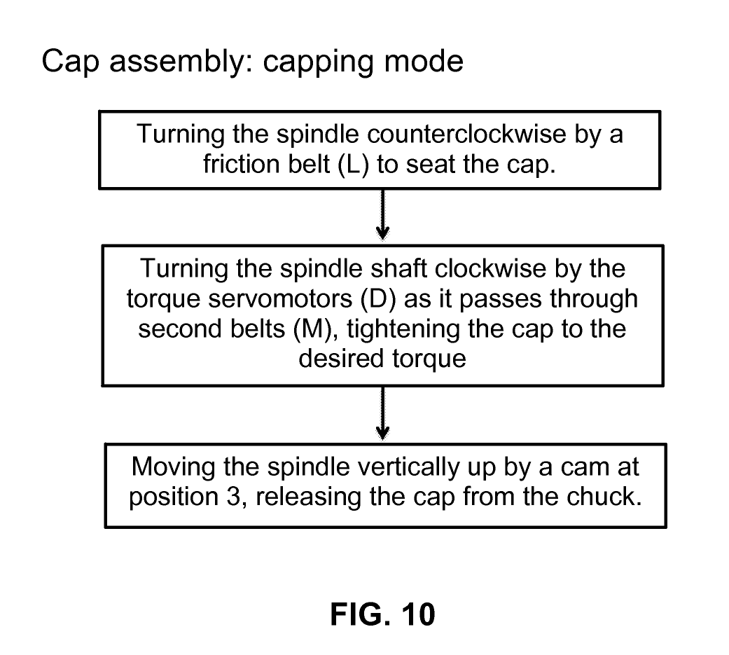

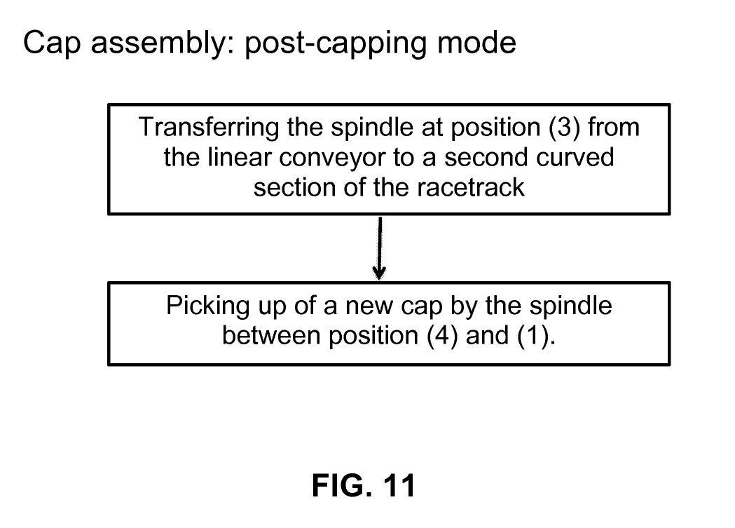

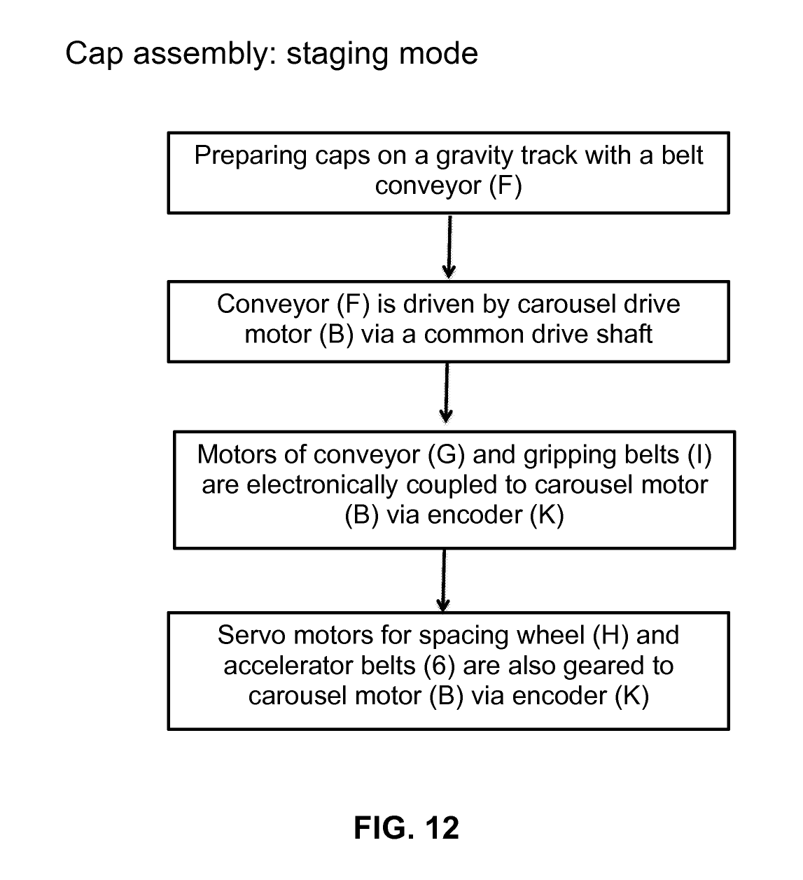

FIGS. 8-12 are related process diagrams of a hybrid bottle capping system.

The bottle handling assembly works in one mode, sending bottles to be capped to the capping section and directing the capped bottle from the capping section for the subsequent processing thereof

The capping head assembly has four operation modes, including a pre-capping mode, capping mode, post capping mode and staging mode.

In the pre-capping mode, the capping head assembly picks up the cap and moves with the bottle, preparing for the capping. In the capping mode, the capping head assembly places the cap onto the bottle and tightens it to the desired torque. In the post-capping mode, the capped bottle is transported away from the cap section and the spindle chuck in the capping head assembly is retracted backwardly. In the staging mode, the capping head assembly prepares for the next capping event.

In a preferred embodiment, referring to FIG. 1-8, the bottle assembly operates as follows:

First, the bottles are transported on a conveyor (G) while spacing the bottles using a spacing wheel; registering the bottles with parallel belts; gripping the bottles by parallel gripping belts (I); and ascertaining the position and speed of the bottle when it enters the gripper belt section by a bottle present sensor (C). In one example, the bottles ride on a conveyor (G) with spacing wheel (H) separating the bottles so that they are about 6 inches apart.

The bottle is then advanced to follow the spindle in order to match the position and speed of the spindle.

Referring to FIGS. 1-7 and 9, the chuck spindles (J) are mounted and moving on a racetrack system, which consists of an AC motor driving a chain. The chain moves the spindle through the linear and curved sections of the racetrack. The bottle sensor (C1) reads the position of the bottle and uses the spacing wheel (H) to adjust the bottle position. The gripper belts (I) further and more precisely adjust the bottle position so that at point 2 the spindle is right above the bottle and moving at the same speed as the bottle. The spindle is turned counterclockwise by a friction belt at position (8) to seat the cap. The spindle shaft is then turned clockwise by the torque belts (M) as it passes through a second pair of belts at position (9), tightening the cap to the desired torque. The vertical movement of the spindle is carried out mechanically via a cam (P)

A new cap is picked up by the spindle between position points (4) and (1).

The caps are picked up from a gravity track having a belt conveyor (F), which is driven by the carousel motor.

Point (5) is a staging point where the bottles are timed to meet the caps.

The invention now being fully described, it will be apparent to one of ordinary skill in the art that many changes and modifications can be made thereto without departing from the spirit or scope of the invention as set forth herein.

1. An automated bottle capping system, comprising:
(a) a bottle handling assembly, comprising
(i) a conveyor belt to transport filled bottles from a prior filling operation, through a spacing mechanism, to time and deliver spaced bottles to a bottle conveyor section of the system;
(b) a capping head assembly, comprising
(i) a cap sorter/feeder adapted to provide caps to a cap pickup section where they are individually fitted to the chuck spindle assemblies, wherein the cap sorter/feeder allows the cap to be completely exposed for pick up;
(ii) multiple chuck spindle assemblies;
(iii) a cap pick up means using one or more of said chuck spindle assemblies to grip the caps;
(iv) a combined pick up/conveying/torqueing means, which:
(A) picks up caps from the cap sorter feeder;
(B) provides a pre-selected amount of torque to spin the caps to a closed configuration;
(C) removes the capped bottles away from the linear capping station to a subsequent handling station for further processing; and
(D) comprises a timing means for pairing said bottles and caps;
(v) wherein the capping head assembly is arranged in a closed loop configuration.

2. The bottle capping system of claim 1, wherein the bottle conveyor section is a linear conveyor section having a pair of parallel gripper belts.

3. The bottle capping system of claim 1, wherein the bottle spacing mechanism is a bottle spacing wheel.

4. The bottle capping system of claim 3, wherein the spacing wheel separates the bottles so as to be 6 inches apart from the neighboring bottle and to carry out initial registration of the bottle with the capping heads.

5. The bottle capping system of claim 1, wherein the closed loop configuration substantially resembles a race track, having opposing curved sections and opposing linear sections.

6. The bottle capping system of claim 5, wherein the curved sections are servo driven.

7. The bottle capping system of claim 5, wherein the racetrack consists of an AC motor-driven chain.

8. The bottle capping system of claim 6, wherein the linear sections are belt driven.

9. The bottle capping system of claim 1, wherein the cap pick up means is provided with cap chuck spindle assemblies.

10. The bottle capping system of claim 1, wherein the chuck spindle assembly further comprises a chuck spindle gripper.

11. The bottle capping system of claim 1, wherein the timing means permits the cap spindle assembly to move at a speed following the speed of the gripper belt.

12. The bottle capping system of claim 1, further comprising an user interface providing on-screen torque adjustment with untorqued cap feedback.

13. A method for capping bottles using an automated system, which comprises:
(a) feeding sorted caps to a pick-up section where they will be individually fitted to the torqueing chuck spindle assemblies;
(b) gripping and transporting the fitted caps using a cap chuck spindle assembly;
(c) separately furnishing filled bottles from a filling station, said bottles being spaced for timing with said caps;
(d) delivering the spaced bottles to a bottle conveyor section;
(e) pairing said caps and bottles using a timing sensor;
(f) fitting the caps to the bottles; and
(g) applying a pre-selected amount of torque to spin the caps to a closed position;
wherein the chuck spindle assembly is mounted around a closed loop.

14. The method of claim 13, wherein the sorted caps in the pick-up section are completely exposed for easy gripping.

15. The method of claim 13, wherein the closed loop substantially resembles a race track configuration, having a curved section and a linear section.

16. The method of claim 15, wherein the racetrack is driven by an AC motor and chain.

17. The method of claim 13, wherein the automated system comprises up to thirteen chuck spindle assemblies.

18. The method of claim 13, wherein the automated system further comprises an user interface providing on-screen torque adjustment with untorqued cap feedback.

19. The method of claim 13, wherein the chuck spindle assembly moves around the loop in a circular motion.

20. The method of claim 15, wherein the racetrack system that said chuck spindle assemblies are mounted on moves around and consists of two levels of linear tracks.
